(19) United States
(12) Patent Application Publication
(10) Pub. No.: US 2006/0288079 A1
(43) Pub. Date: Dec. 21, 2006

(54) Security system for personal Internet communicator

(76) Inventor: Martyn G. Deobald, Longmont, CO (US)

Correspondence Address: HAMILTON & TERRILE. LLP, P.O. BOX 203518, AUSTIN, TX, 78720, US

(21) Appl. No.: 11/141,303

(22) Filed: May 31, 2005

(51) Int. Cl. G06F 15/16

(52) U.S. Cl. 709/217

(57) ABSTRACT

The present invention provides a method and apparatus to prevent permanent storage of Internet-related files on the hard disk or other permanent storage of a user's personal computer. In an embodiment of the present invention, a portion of the computer's volatile random access memory (RAM) is used to form a RAM disk. This RAM disk is then used to store all Internet-related files related to data exchange over the Internet. When the user's personal computer is turned off, the contents of the RAM disk are erased, thereby deleting all Internet-related files. In another embodiment of the present invention, the RAM disk is populated with a set of predetermined user-specific files immediately after the RAM disk is created. These user-specific files are used to provide a predetermined set of functionality for the user's use of the Internet. In yet another embodiment of the invention, the predetermined set of user-specific files are determined by a unique user identifier (UUID) that is associated with an Internet account provided by an Internet service provider (ISP).

### BACKGROUND OF THE INVENTION

1. Field of the Invention

The present invention relates to the field of information processing systems and, more particularly, to a system and method for enhancing security for users of computer systems used to communicate over the Internet.

2. Description of the Related Art

Computer systems have attained widespread use for providing information management capability to many segments of today's society. A personal computer system can usually be defined as a microcomputer that includes a system unit having a system processor and associated volatile and non-volatile memory, a display monitor, a keyboard, a fixed disk storage device, an optional removable storage device and an optional printer. These personal computer systems are information handling systems which are designed primarily to give independent computing power to a single user (or a group of users in the case of personal computers which serve as computer server systems) and are inexpensively priced for purchase by individuals or small businesses.

In recent years, there has been significant growth in the use of the personal computers to exchange information over the Internet. This exchange of information is based on a client/server model with the user's personal computer operating as the client to access data stored on a plurality of Internet servers. When computers exchange information over the Internet, browser programs typically store files on the user's hard drive to facilitate the exchange of information. Examples of files stored on the hard disk may include “cookies,” cache files and data files related to the history of the data exchanges. Some files, such as cookies, may be undesirable because these files allow tracking of user habits and can be used to target undesired advertising to the user. In addition, the accumulation of cookies and other Internet-related files can result in inefficient hard disk performance. It would be desirable, therefore, to provide a method and apparatus to prevent permanent storage of Internet-related files on the hard disk or other permanent storage of a user's personal computer.

### SUMMARY OF THE INVENTION

The present invention provides a method and apparatus to prevent permanent storage of Internet-related files on the hard disk or other permanent storage of a user's personal computer. In an embodiment of the present invention, a portion of the computer's volatile random access memory (RAM) is used to form a RAM disk. This RAM disk is then used to store all Internet-related files related to data exchange over the Internet. When the user's personal computer is turned off, the contents of the RAM disk are erased, thereby deleting all Internet-related files.

In another embodiment of the present invention, the RAM disk is populated with a set of predetermined user-specific files immediately after the RAM disk is created. These user-specific files are used to provide a predetermined set of functionality for the user's use of the Internet. In yet another embodiment of the invention, the predetermined set of user-specific files are determined by a unique user identifier (UUID) that is associated with an Internet account provided by an Internet service provider (ISP).

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a block diagram of a network of computers communicating over one or more communication networks.

FIG. 2 is a system block diagram of a computer system, such as a personal Internet communicator, in accordance with the present invention.

FIG. 3 is a block diagram of the computer system of FIG. 4, showing the transport and storage of Internet-related files in a RAM disk.

FIG. 4 is a flow diagram of the present invention for using a RAM disk to store Internet-related files to increase security in a personal Internet communicator.

### DETAILED DESCRIPTION

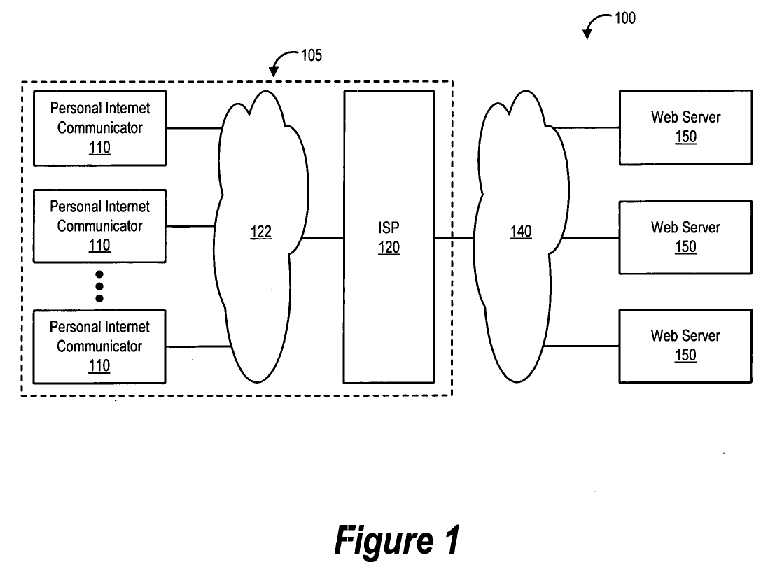

FIG. 1 is a block diagram of a network 100 comprising a plurality of computer systems 110, hereinafter referred to as a “multimedia access devices” or “personal Internet communicators” (PICs) that are operably coupled to an Internet service provider 120 via a communication link 122. The Internet service provider 120 is coupled to the Internet 140 that is further coupled to a plurality of Web host servers 150. A user wishing to access information on the Internet uses the PIC to execute an application program known as a Web browser.

The PIC 110 includes communication hardware and software that allows the PIC 110 to send and receive communications to and from the Internet service provider 120. The communications hardware and software allows the PIC 110 to establish a communication link with the Internet service provider 120. The communication link may be any of a variety of connection types including a wired connection, a direct link such as a digital subscriber line (DSL), T1, integrated services digital network (ISDN) or cable connection, a wireless connection via a cellular or satellite network or a local data transport system such as Ethernet or token ring over a local area network.

When the customer enters a request for information by entering commands in the Web browser, the PIC 110 sends a request for information, such as a search for documents pertaining to a specified topic, or a specific Web page to the Internet service provider 120 which in turn forwards the request to an appropriate Web host server 150 via the Internet 140. The Internet service provider 120 executes software for receiving and reading requests sent from the browser. The Internet service provider 120 executes a Web server application program that monitors requests, services requests for the information on that particular Web server, and transmits the information to the user's PIC 110.

Each Web host server 150 on the Internet has a known address that the user supplies to the Web browser to connect to the appropriate Web host server 150. If the information is not available on the user's Web host server 150, the Internet 140 serves as a central link that allows Web servers 150 to communicate with one another to supply the requested information. Because Web servers 150 can contain more than one Web page, the user will also specify in the address which particular Web page he wants to view. The address, also known as a universal resource locator (URL), of a home page on a server is a series of numbers that indicate the server and the location of the page on the server, analogous to a post office address. For simplicity, a domain name system was developed that allows users to specify servers and documents using names instead of numbers. A URL may further specify a particular page in a group of pages belonging to a content provider by including additional information at the end of a domain name.

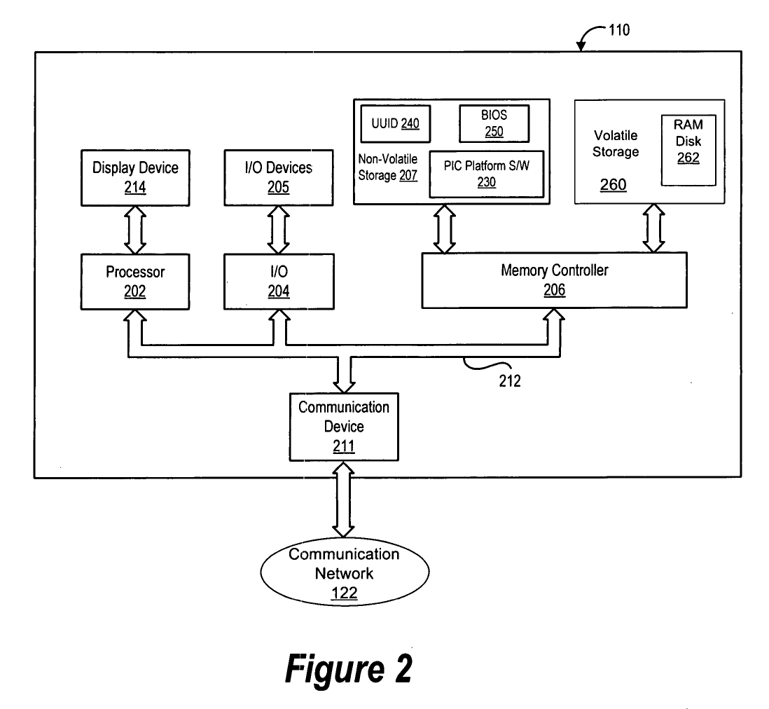

Referring to FIG. 2, a block diagram of PIC 110 is shown. The PIC 110 includes a processor 202, input/output (I/O) control device 204 which is coupled to I/O devices 205 such as a keyboard and a mouse. A memory controller 206 is operable to control non-volatile storage 207 and volatile storage 260 as described in greater detail hereinbelow.

The processor 202, I/O controller 204, memory controller 206 and communication device 211 are interconnected via one or more buses 212. The processor 202 is also configured to be coupled to a display device 214. The PIC 110 is connected to communication network 122 and the Internet 140 by a communication device 211 that may be a modem or other appropriate network communication device known to those of skill in the art.

The non-volatile storage 207 includes PIC software 230 that may be stored on a hard drive and executed by processor 202. The nonvolatile storage also includes a unique user identifier (UUID) 240 that may be stored on a read only memory device (ROM) or on a hardwired integrated circuit. The non-volatile storage 207 also includes a boot ROM device to store and boot from the BIOS 250.

The volatile memory 260 comprises random access memory (RAM) with a portion of the RAM being controlled to act as a RAM disk using techniques known to those of skill in the art. As discussed hereinabove, during the exchange of information between the PIC and a Web server it is very common for the Web server to use the browser program to store files on the PIC hard drive to facilitate the exchange of information. Examples of files stored on the hard disk may include “cookies,” cache files and data files related to the history of the data exchanges. Some of the stored files, such as cookies, may be undesirable because these files allow tracking of user habits and can be used to target undesired advertising to the user.

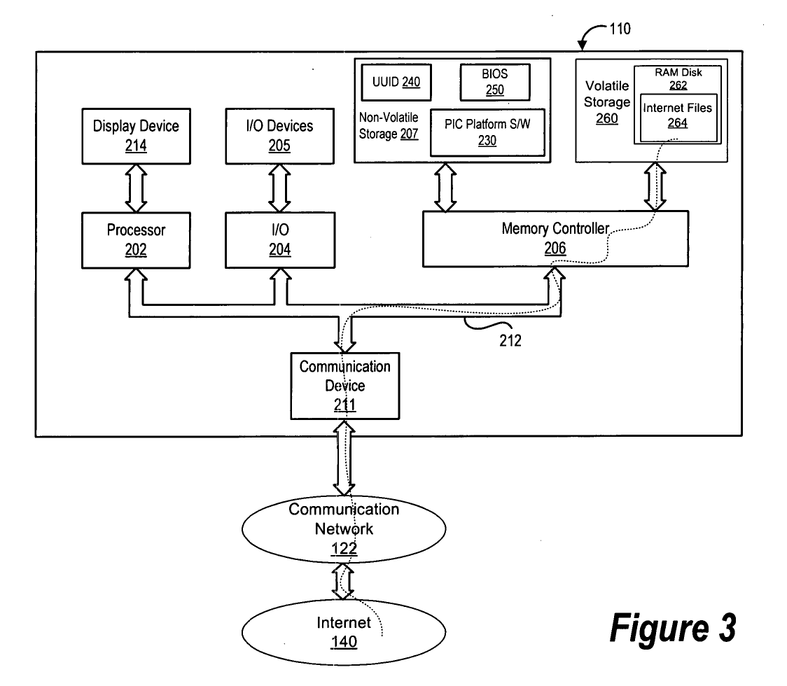

In the method and apparatus of the present invention, the RAM disk 262 is used to store Internet-related files as illustrated in FIG. 3. The RAM disk 264 used to store all Internet-related files related to data exchange over the Internet during a user session on the PIC 110. When the PIC 110 is turned off, the contents of the RAM disk are erased, thereby deleting all Internet-related files.

In another embodiment of the present invention, the RAM disk 264 is populated with a set of predetermined user-specific files immediately after It is created. These user-specific files are used to provide a predetermined set of functionality for the user's use of the Internet. In various embodiments of the invention, the predetermined set of user-specific files are determined by a unique user identifier (UUID) that is associated with an Internet account provided by the ISP 120.

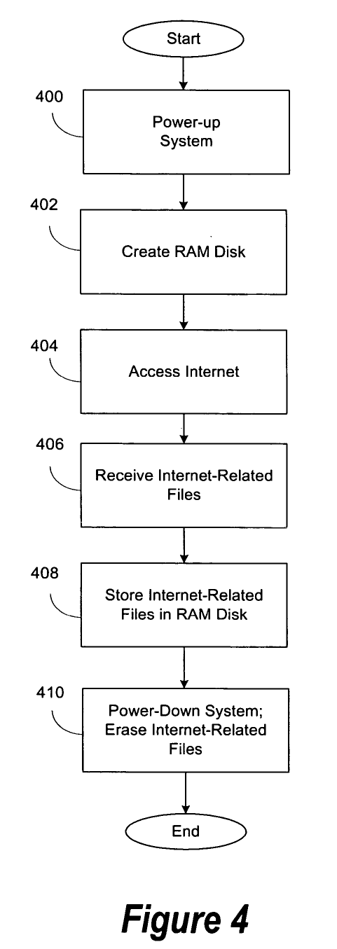

FIG. 4 is a flow diagram illustrating the processing steps for implementing the present invention. In step 400, the personal Internet communicator 110 is powered up and, in step 402, the memory controller 206 creates a RAM disk in the volatile storage 260. In step 404, the user uses the personal Internet communicator 110 to access the Internet using a web browser. In step 406, Internet-related files 264 are received from the Internet and, in step 408, the Internet-related files 264 are stored in the RAM disk 262. After the user session is terminated, the personal Internet communicator 110 is powered down and the Internet related files 264 stored in the RAM disk 262 are erased.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Although the present invention has been described in detail, it should be understood that various changes, substitutions and alterations can be made hereto without departing from the spirit and scope of the invention as defined by the appended claims.

What is claimed is:

1. A personal Internet communicator, comprising:
a communication interface operable to transfer of data between said personal Internet communicator and the Internet;
a volatile memory;
a memory controller operable to control a portion of said volatile memory for operation as a RAM disk; and
a data processor operable to control transfer of files between said personal internet communicator and the Internet, wherein said data processor stores internet related files in said RAM disk in said volatile memory.

2. The personal Internet communicator according to claim 1, wherein said Internet-related files are erased upon loss of power to operate said volatile memory.

3. The personal Internet communicator according to claim 1, wherein said Internet-related files comprise cookies.

4. The personal Internet communicator according to claim 1, further comprising non-volatile memory, said non-volatile memory having a unique user identifier stored therein.

5. The personal Internet communicator according to claim 4, wherein said RAM disk is populated with a set of predetermined user data.

6. The personal Internet communicator according to claim 5, wherein said set of predetermined user data is transferred to said RAM disk from said nonvolatile memory.

7. The personal Internet communicator according to claim 6, wherein the content of said set of predetermined user data is based upon an authorized set of user data associated with said unique user identifier.

8. The personal Internet communicator according to claim 7, wherein said unique user identifier is used to control the files transferred between said personal Internet communicator and the Internet.

9. The personal Internet communicator according to claim 5, wherein said set of predetermined user data is transferred to said RAM disk by an Internet service provider over a communication network.

10. The personal Internet communicator according to claim 9, wherein the content of said set of predetermined user data based upon an authorized set of user data associated with said unique user identifier.

11. The personal Internet communicator according to claim 10, wherein said unique user identifier is used to control the files transferred between said personal Internet communicator and the Internet.

12. A method of providing security for a personal Internet communicator, comprising:
using a memory controller to create a RAM disk in a volatile memory;
using a communication interface to transfer of data between said personal Internet communicator and the Internet; and
a data processor operable to control transfer of files between said personal internet communicator and the Internet, wherein said data processor stores internet related files in said RAM disk in said volatile memory.

13. The method according to claim 12, wherein said Internet-related files are erased upon loss of power to operate said volatile memory.

14. The method according to claim 12, wherein said Internet-related files comprise cookies.

15. The method according to claim 12, further comprising storing a unique user identifier in a non-volatile memory.

16. The method according to claim 15, wherein said RAM disk is populated with a set of predetermined user data.

17. The method according to claim 16, wherein said set of predetermined user data is transferred to said RAM disk from said nonvolatile memory.

18. The method according to claim 17, wherein the content of said set of predetermined user data is based upon an authorized set of user data associated with said unique user identifier.

19. The method according to claim 18, wherein said unique user identifier is used to control the files transferred between said personal Internet communicator and the Internet.

20. The method according to claim 16, wherein said set of predetermined user data is transferred to said RAM disk by an Internet service provider over a communication network.

21. The method according to claim 20, wherein the content of said set of predetermined user data based upon an authorized set of user data associated with said unique user identifier.

22. The method according to claim 21, wherein said unique user identifier is used to control the files transferred between said personal Internet communicator and the Internet.
